(19) United States
(12) Patent Application Publication
(10) Pub. No.: US 2016/0118071 A1
(43) Pub. Date: Apr. 28, 2016

(54) PERPENDICULAR MAGNETIC RECORDING MEDIUM AND MAGNETIC STORAGE APPARATUS USING THE SAME

(71) Applicant: HGST Netherlands B.V., Amsterdam (NL)

(72) Inventors: Akemi Hirotsune, Odawara-shi (JP); Ikuko Takekuma, Yokohama-shi (JP); Naoto Ito, Fujisawa-shi (JP); Hiroyuki Matsumoto, Chigasaki-shi (JP)

(73) Assignee: HGST NETHERLANDS B.V., Amsterdam (NL)

(21) Appl. No.: 14/522,554

(22) Filed: Oct. 23, 2014

(51) Int. Cl. G11B 5/66; G11B 5/667; G11B 5/64; G11B 5/55; G11B 5/127

(52) U.S. Cl. CPC G11B 5/66; G11B 5/5521; G11B 5/1278; G11B 5/645; G11B 5/667

(57) ABSTRACT

In one embodiment, a perpendicular magnetic recording medium includes: a substrate; an underlayer positioned above the substrate; and a magnetic recording layer structure positioned above the underlayer, where the magnetic recording layer structure includes at least a first magnetic recording layer and a second magnetic recording layer, the second magnetic layer being positioned above first magnetic recording layer, where the first magnetic recording layer includes a first segregant material positioned between magnetic grains thereof, the first segregant material being primarily boron nitride (BN), and where the second magnetic recording layer includes a second segregant material positioned between the magnetic grains thereof, the second segregant material being primarily an oxide.

### FIELD OF THE INVENTION

The present invention relates to data storage systems, and more particularly, this invention relates to magnetic recording media having a surface recording density of 1 terabit or more per square inch.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. Accordingly, an important and ongoing goal involves increasing the amount of information able to be stored in the limited area and volume of HDDs. Increasing the areal recording density of HDDs provides one technical approach to achieve this goal. In particular, reducing the size of recording bits and components associated therewith offers an effective means to increase areal recording density. However, the continual push to miniaturize the recording bits and associated components presents its own set of challenges and obstacles. For instance, as the size of the ferromagnetic crystal grains in a magnetic recording layer become smaller and smaller, the crystal grains may become thermally unstable, such that thermal fluctuations result in magnetization reversal and the loss of recorded data. Increasing the magnetic anisotropy of the magnetic particles may improve the thermal stability thereof; however, an increase in the magnetic anisotropy requires an increase in the switching field needed to switch the magnetization of the magnetic particles during a write operation.

### SUMMARY

According to one embodiment, a perpendicular magnetic recording medium includes: a substrate; an underlayer positioned above the substrate; and a magnetic recording layer structure positioned above the underlayer, where the magnetic recording layer structure includes at least a first magnetic recording layer and a second magnetic recording layer, the second magnetic layer being positioned above first magnetic recording layer, where the first magnetic recording layer includes a first segregant material positioned between magnetic grains thereof, the first segregant material being primarily boron nitride (BN), and where the second magnetic recording layer includes a second segregant material positioned between the magnetic grains thereof, the second segregant material being primarily an oxide.

According to another embodiment, a perpendicular magnetic recording medium includes: a substrate; and a magnetic recording layer structure positioned above the substrate, the magnetic recording layer structure including: a first magnetic recording layer having a first segregant material positioned between magnetic grains thereof; and a second magnetic recording layer positioned above first magnetic recording layer, the second magnetic recording layer having a second segregant material positioned between the magnetic grains thereof, where the magnetic grains of the first and second magnetic recording layers include a L1₀ type FePt ordered alloy, and where at least the second segregant has a thermal conductivity that is less than FePt.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system, according to one embodiment.

FIG. 2A is a cross-sectional view of a perpendicular magnetic head with helical coils, according to one embodiment.

FIG. 2B is a cross-sectional view a piggyback magnetic head with helical coils, according to one embodiment.

FIG. 3A is a cross-sectional view of a perpendicular magnetic head with looped coils, according to one embodiment.

FIG. 3B is a cross-sectional view of a piggyback magnetic head with looped coils, according to one embodiment.

FIG. 4A is a schematic representation of a section of a longitudinal recording medium, according to one embodiment.

FIG. 4B is a schematic representation of a magnetic recording head and the longitudinal recording medium of FIG. 4A, according to one embodiment.

FIG. 5A is a schematic representation of a perpendicular recording medium, according to one embodiment.

FIG. 5B is a schematic representation of a recording head and the perpendicular recording medium of FIG. 5A, according to one embodiment.

FIGS. 6A-6D are partial cross sectional views of magnetic media, according to various embodiments.

FIG. 7 is a partial cross sectional view of a magnetic recording medium, according to one embodiment.

FIGS. 8A-8D show scanning electron microscope (SEM) images of the grain size associated with various magnetic media, according to some embodiments.

FIG. 9 shows the average grain pitch for various magnetic recording media, according to some embodiments.

FIG. 10 shows the surface roughness (Rq) for various magnetic recording media, according to some embodiments.

FIG. 11 shows a plot of the magnetic write width (MWW) versus the laser current applied during recording for various magnetic recording media, according to some embodiments.

FIG. 12 shows a plot of the MWW versus the BN content in the grain boundary material of a first magnetic layer of a magnetic recording medium, according to one embodiment.

FIG. 13 shows a plot of the surface roughness (Rq) versus the oxide content in the grain boundary material of the second magnetic layer of a magnetic medium, according to one embodiment.

FIG. 14 shows a plot of the signal and laser current strengths versus the total thickness of a magnetic recording layer structure of a magnetic medium, according to one embodiment.

FIG. 15 shows a plot of the percentage thickness of the first magnetic recording layer relative to the total thickness of a magnetic recording layer structure versus the grain pitch and surface roughness of a magnetic medium, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm.

The following description discloses several preferred embodiments of magnetic storage systems and/or related systems and methods, as well as operation and/or component parts thereof.

Efforts are continually made to increase the areal recording density of magnetic media. Areal density, e.g., as measured in bits per square inch, may be defined as the product of the track density (the tracks per inch radially on the magnetic medium, such as a disk) and the linear density (the bits per inch along each track). For a disk, the bits are written closely-spaced to form circular tracks on the disk surface, where each of the bits may comprise an ensemble of magnetic grains.

An important factor relevant to track density is the magnetic write width (MWW). The magnetic write width determines the width of a magnetic bit recorded by the write/main pole of the write head. Thus, the smaller the magnetic write width, the greater the number of tracks of data that can be written to the media. Stated another way, high track density is associated with a narrow magnetic write width.

Moreover, an important factor relevant to linear density is the signal to noise ratio (SNR). Typically, a higher signal to noise ratio corresponds to a higher readable linear density. One approach to increase the signal to noise ratio involves reducing the size of the magnetic grains included within a magnetic recording layer. However, reducing the size of the magnetic grains may affect their thermal stability, which is given by: KᵤV/k_{b}T, where Kᵤ denotes the magnetocrystalline anisotropy, V is the average grain volume, kb denotes the Boltzmann constant, and T denotes the temperature. Preferably, KᵤV/k_{b}T>˜60 to avoid thermal decay. Accordingly, to compensate for the reduction in volume, V, of the magnetic nanoparticles, the magnetic anisotropy (Kᵤ) of the magnetic nanoparticles may be increased to maintain thermal stability. However, increasing the magnetic anisotropy also increases the coercivity of the ferromagnetic recording material, which may exceed the switching field (i.e., the write field) capability of the write head.

Heat assisted magnetic recording (HAMR), also referred to as thermally assisted magnetic recording, has emerged as a promising magnetic recording technique to address the difficulty in maintaining both the thermal stability and write-ability of the magnetic media. As the coercivity of the ferromagnetic recording material is temperature dependent, HAMR employs heat to lower the effective coercivity of a localized region of the magnetic media and write data therein. The data state becomes stored, or “fixed,” upon cooling the magnetic media to ambient temperatures (i.e., normal operating temperatures typically in a range between about 15° C. and 60° C.). HAMR thus allows use of ferromagnetic recording materials with substantially higher magnetic anisotropy and smaller thermally stable grains as compared to conventional magnetic recording techniques.

As discussed previously, achieving a higher surface recording density in a magnetic recording medium while maintaining thermal stability requires a magnetic recording layer having high perpendicular magnetic anisotropic energy, Kᵤ. CoCr-based and CoCrPt-based alloys have been employed as magnetic recording layer material. However, CoCr- and CoCrPt-based alloys do not possess a magnetic anisotropic constant that is suitable (e.g. high enough) to achieve surface recording densities exceeding 1 Tbit/inch². Accordingly, to satisfy the continued push to increase the recording density of a magnetic recording medium, materials with higher magnetic anisotropic constants than a Co—Cr-based alloy must be employed.

An L1₀ type FePt ordered alloy is a material that has higher perpendicular magnetic recording anisotropic energy Kᵤ than current CoCrPt-based alloys, and has thus attracted attention as a material for next-generation magnetic recording layers. Such an ordered alloy has a structure in which the different atoms therein are arranged in a regular/ordered fashion (e.g., there is a regular/ordered arrangement of the atoms among the atomic sites in the crystal lattice of the alloy). L1₀ type FePt ordered alloys have been described, for example, in Nature photonics, Vol. 3, No. 4, pp. 189-190, April 2009, “Data Storage: Heat-assisted Magnetic Recording”.

Exchange interaction between crystal lattices must be reduced to use this L1₀ type FePt ordered alloy as a magnetic recording layer. One approach to reduce this exchange interaction involves granulating the L1₀ type FePt ordered alloy, whereby a nonmagnetic material such as SiO₂ or C is added to the alloy. An example of this approach is disclosed in Japanese Unexamined Patent Publication No. 2008-91024. A granulated L1₀ type FePt ordered alloy comprises magnetic crystal grains comprising primarily FePt, which are surrounded by crystal grain boundaries of a nonmagnetic material such that the magnetic crystal grains are magnetically divided.

Generally, using an FePt alloy having an L1₀ type crystal structure for a magnetic recording layer requires that the FePt layer take on a (001) orientation. It is known in the art that ordering FePt to form a (001) orientation requires heating the FePt alloy to 300° C. or higher prior to, during and/or after film formation. One example of such a heating process is disclosed in Japanese Unexamined Patent Document No. 2012-048784. It is also known in the art that the (001) orientation of a FePt alloy may be formed by using a suitable material for an underlayer that is positioned underneath the FePt layer. For instance, use of an MgO underlayer results in the FePt layer having a (001) orientation, as discussed in IEEE Transactions on Magnetics, Vol. 42, No. 10, October 2006, pp. 3017-3019, “Interfacial Effects of MgO Buffer Layer on Perpendicular Anisotropy of L1₀ FePt films”.

The high recording anisotropic energy Kᵤ of an L1₀ type FePt ordered alloy makes it particularly useful as a magnetic recording material for HAMR. Thermal management is an important factor in HAMR recording. For example, while a magnetic medium needs to be heated to high temperatures (e.g. at least 100K above the Curie temperature) during the writing process, the medium also needs to be cooled quickly in order to avoid thermal destabilization of the written information. Conventional heat sink layers are thus typically used in a HAMR medium to conduct or direct heat away from the recording layer after writing in order to limit thermal erasure, and thus obtain a high SNR and narrow recording width. Such heat sink layers are preferably positioned underneath the orientation controlling underlayer (e.g., the MgO underlayer noted above). Additionally, such heat sink layers may generally have a crystallographic orientation substantially aligned with that of the underlayer, as well as a greater thermal conductivity than said underlayer. However, conventional heat sink layers may conduct heat both vertically and laterally, thereby resulting in possible lateral thermal spreading during the writing process, which may limit track density and the size of the data bits. Indeed, the use of conventional heat sink layers is often insufficient to form ultra-micro recording bits, there the recording width and recording length approaches 100 nm and 50 nm, respectively.

Furthermore, the use of conventional non-magnetic materials such as SiO₂ or C to granulate the L1₀ type FePt ordered alloy may also contribute to unwanted lateral thermal spreading, as these non-magnetic materials have a greater thermal conductivity than FePt and tend to transmit heat in the in-plane direction during the writing process. Moreover, the use of SiO₂ as the non-magnetic material often leads to poor grain separation in the L1₀ type FePt ordered alloy. Moreover still, the use of C as the non-magnetic material generally results in the formation of spherical FePt magnetic grains, which undesirably limits the achievable thickness of the media for a given average grain diameter, thereby imposing a serious limitation on the signal strength of the media.

Embodiments described herein overcome the aforementioned drawbacks by providing a magnetic recording medium including at least the following layers positioned above a substrate in the following order: a buffer layer, an underlayer, and a multilayer recording layer. In some approaches, the buffer layer may have an amorphous structure. In other approaches, the buffer layer may have a body centered cubic (bcc) crystal structure. In additional approaches, the multilayer recording layer may comprise at least two granulated recording layers each of which have a L1₀ type crystal structure. In preferred approaches, the granulated recording layer positioned closest to the substrate includes a BN segregant, and the granulated recording layer positioned farthest from the substrate includes an oxide segregant. As discussed in detail below, the structure and composition of the multilayer recording layers disclosed herein promote good grain separation, low surface roughness and minimal heat transmittance in the in-plane direction during recording, thus enabling high density recording.

Following are several examples of general and specific embodiments relating to the use, manufacture, structure, properties, etc. of the novel magnetic media disclosed herein.

In one general embodiment, a perpendicular magnetic recording medium includes: a substrate; an underlayer positioned above the substrate; and a magnetic recording layer structure positioned above the underlayer, where the magnetic recording layer structure includes at least a first magnetic recording layer and a second magnetic recording layer, the second magnetic layer being positioned above first magnetic recording layer, where the first magnetic recording layer includes a first segregant material positioned between magnetic grains thereof, the first segregant material being primarily boron nitride (BN), and where the second magnetic recording layer includes a second segregant material positioned between the magnetic grains thereof, the second segregant material being primarily an oxide.

In another general embodiment, a perpendicular magnetic recording medium includes: a substrate; and a magnetic recording layer structure positioned above the substrate, the magnetic recording layer structure including: a first magnetic recording layer having a first segregant material positioned between magnetic grains thereof; and a second magnetic recording layer positioned above first magnetic recording layer, the second magnetic recording layer having a second segregant material positioned between the magnetic grains thereof, where the magnetic grains of the first and second magnetic recording layers include a L1₀ type FePt ordered alloy, and where at least the second segregant has a thermal conductivity that is less than FePt.

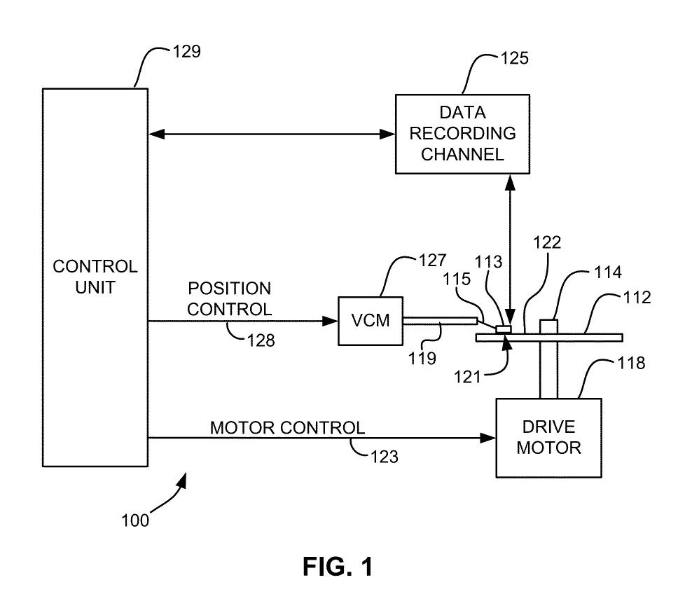

Referring now to FIG. 1, a disk drive 100 is shown in accordance with one embodiment. As an option, the disk drive 100 may be implemented in conjunction with features from any other embodiment listed herein, such as those described with reference to the other FIGS. Of course, the disk drive 100 and others presented herein may be used in various applications and/or in permutations which may or may not be specifically described in the illustrative embodiments listed herein.

As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is formed between the first and second pole piece layers by a gap layer at an air bearing surface (ABS) of the write portion. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

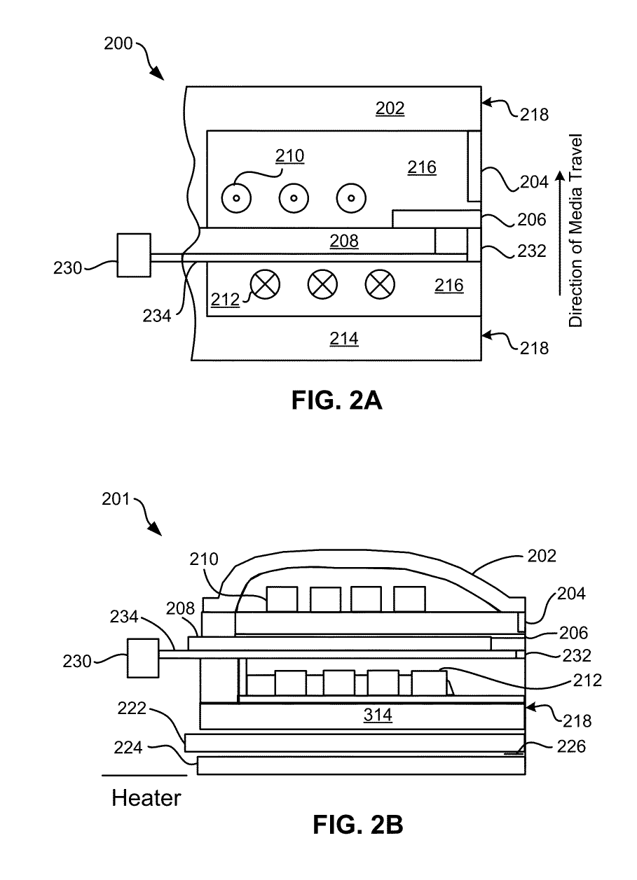

FIGS. 2A and 2B provide cross-sectional views of a magnetic head 200 and a piggyback magnetic head 201, according to various embodiments. As an option, the magnetic heads 200, 201 may be implemented in conjunction with features from any other embodiment listed herein, such as those described with reference to the other FIGS. Of course, the magnetic heads 200, 201 and others presented herein may be used in various applications and/or in permutations which may or may not be specifically described in the illustrative embodiments listed herein.

As shown in the magnetic head 200 of FIG. 2A, helical coils 210 and 212 are used to create magnetic flux in the stitch pole 208, which then delivers that flux to the main pole 206. Coils 210 indicate coils extending out from the page, while coils 212 indicate coils extending into the page. Stitch pole 208 may be recessed from the ABS 218. Insulation 216 surrounds the coils and may provide support for some of the elements. The direction of the media travel, as indicated by the arrow to the right of the structure, moves the media past the lower return pole 214 first, then past the stitch pole 208, main pole 206, trailing shield 204 which may be connected to the wrap around shield (not shown), and finally past the upper return pole 202. Each of these components may have a portion in contact with the ABS 218. The ABS 218 is indicated across the right side of the structure.

Perpendicular writing is achieved by forcing flux through the stitch pole 208 into the main pole 206 and then to the surface of the disk positioned towards the ABS 218.

In various optional approaches, the magnetic head 200 may be configured for heat assisted magnetic recording (HAMR). Accordingly, for HAMR operation, the magnetic head 200 may include a heating mechanism of any known type to heat the magnetic medium (not shown). For instance, as shown in FIG. 2A according to one in one particular approach, the magnetic head 200 may include a light source 230 (e.g., a laser) that illuminates a near field transducer 232 of known type via a waveguide 234.

FIG. 2B illustrates one embodiment of a piggyback magnetic head 201 having similar features to the head 200 of FIG. 2A. As shown in FIG. 2B, two shields 204, 214 flank the stitch pole 208 and main pole 206. Also sensor shields 222, 224 are shown. The sensor 226 is typically positioned between the sensor shields 222, 224.

An optional heater is shown in FIG. 2B near the non-ABS side of the piggyback magnetic head 201. A heater (Heater) may also be included in the magnetic head 200 of FIG. 2A. The position of this heater may vary based on design parameters such as where the protrusion is desired, coefficients of thermal expansion of the surrounding layers, etc.

Moreover, in various optional approaches, the piggyback magnetic head 201 may also be configured for heat assisted magnetic recording (HAMR). Thus, for HAMR operation, the magnetic head 200 may additionally include a light source 230 (e.g., a laser) that illuminates a near field transducer 232 of known type via a waveguide 234.

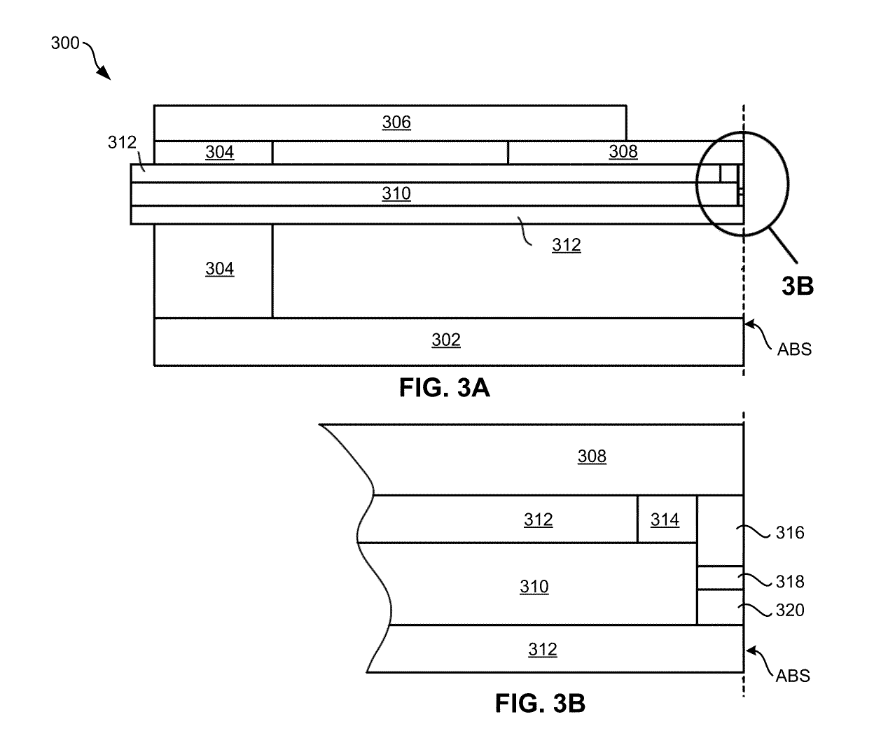

Referring now to FIG. 3A, a partial cross section view of a system 300 having a thin film perpendicular write head design incorporating an integrated aperture near field optical source (e.g., for HAMR operation) is shown according to one embodiment. As an option, this system 300 may be implemented in conjunction with features from any other embodiment listed herein, such as those described with reference to the other FIGS. Of course, such a system 300 and others presented herein may be used in various applications and/or in permutations which may or may not be specifically described in the illustrative embodiments listed herein. Moreover, in order to simplify and clarify the general structure and configuration of the system 300, spacing layers, insulating layers, and write coil layers may be omitted from FIG. 3.

As shown in FIG. 3A, the write head has a lower return pole layer 302, back-gap layer(s) 304, upper return pole layer 306, and upper pole tip layer 308. In one approach, the lower return pole layer 302 may also have a lower pole tip (not shown) at the ABS. Layer 310 is an optical waveguide core, which may be used while conducting HAMR, e.g., to guide light from a light source to heat a medium (not shown) at the ABS when the system 300 is writing thereto. According to a preferred approach, the optical waveguide core is surrounded by cladding layers 312. Moreover, layers 310 and 312 may extend through at least a portion of back-gap layer(s) 304. The components inside of Circle 3B are shown in an expanded view in FIG. 3B, as discussed in further detail below.

Layer 310 may be comprised of a suitable light transmitting material, as would be known by one of reasonable skill in the relevant art. Exemplary materials include Ta₂O₅, and/or TiO₂. As shown, the core layer 310 has approximately uniform cross section along its length. As well known in the art, the optical waveguide can have a number of other possible designs including a planar solid immersion mirror or planar solid immersion lens which have a non-uniform core cross section along the waveguide's length.

In various approaches, coil layers (not shown) and various insulating and spacer layers (not shown) might reside in the cavity bounded by the ABS, back-gap(s) 304, lower return pole 302, and/or upper bounding layers 306, 308, and 312 as would be recognized by those of skill in the art. Layers 302, 304, 306, and 308 may be comprised of a suitable magnetic alloy or material, as would be known by one of reasonable skill in the relevant art. Exemplary materials include Co, Fe, Ni, Cr and combinations thereof.

As described above, FIG. 3B is a partial cross section expanded view of detail 3B in FIG. 3A, in accordance with one embodiment. Pole lip 316 is magnetically coupled to upper pole tip layer 308, and to optional magnetic step layer 314. Aperture 318 (also known as a ridge aperture), surrounding metal layer 320, and pole lip 316 comprise the near field aperture optical source (or near field transducer), which is supplied optical energy via optical waveguide core 310. Pole lip 316 and optional magnetic step layer 314 may be comprised of a suitable magnetic alloy, such as Co, Fe, Ni, Cr and/or combinations thereof. Metal layer 320 may be comprised of Cu, Au, Ag, and/or alloys thereof, etc.

With continued reference to FIG. 3B, cladding layer 312 thickness may be nominally about 300 nm, but may be thicker or thinner depending on the dimensions of other layers in the structure. Optional magnetic step layer 314 may have a nominal thickness (the dimension between layers 308 and 310) of about 300 nm, and a nominal depth (as measured from layer 316 to layer 312) of about 180 nm. Pole lip 316 may have a nominal depth (as measured from the ABS) approximately equal to that of layer 320, with the value being determined by the performance and properties of the near field optical source (see examples below). The thickness of the pole lip 316 can vary from about 150 nm (with the optional magnetic step layer 314) to about 1 micron, preferably between about 250 nm and about 350 nm. The thickness of optical waveguide core layer 310 may be nominally between about 200 nm and about 400 nm, sufficient to cover the thickness of the aperture 318. In the structure shown in FIG. 3B, the layer 308 extends to the ABS. In some preferred embodiments, the layer 308 may be recessed from the ABS while maintaining magnetic coupling with the layers 314 and 316.

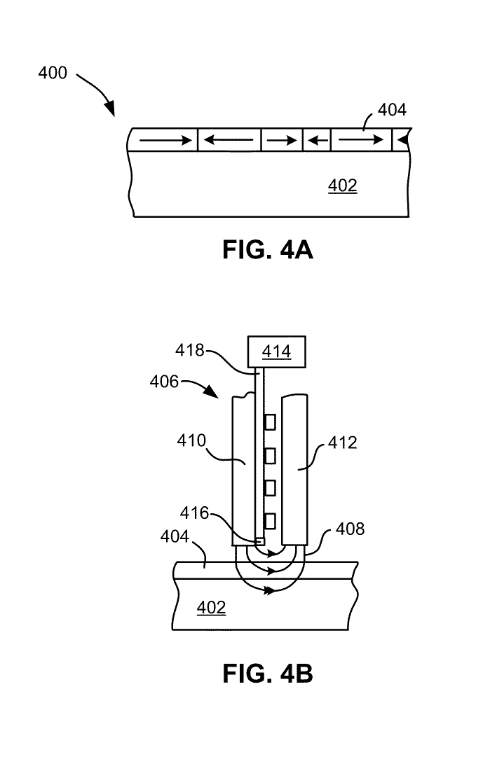

FIG. 4A provides a schematic illustration of a longitudinal recording medium 400 typically used with magnetic disc recording systems, such as that shown in FIG. 1. This longitudinal recording medium 400 is utilized for recording magnetic impulses in (or parallel to) the plane of the medium itself. This longitudinal recording medium 400, which may be a recording disc in various approaches, comprises at least a supporting substrate 402 of a suitable non-magnetic material such as glass, and a conventional magnetic recording layer 404 positioned above the substrate.

FIG. 4B shows the operative relationship between a recording/playback head 406, which may preferably be a thin film head and/or other suitable head as would be recognized by one having skill in the art upon reading the present disclosure, and the longitudinal recording medium 400 of FIG. 4A. As shown in FIG. 4B, the magnetic flux 408, which extends between the main pole 410 and return pole 412 of the recording/playback head 406, loops into and out of the magnetic recording layer 404.

In various optional approaches, the recording/playback head 406 may additionally be configured for heat assisted magnetic recording (HAMR). Accordingly, for HAMR operation, the recording/playback head 406 may include a heating mechanism of any known type to heat, and thus lower the effective coercivity, of a localized region on the magnetic medium 400 surface in the vicinity of the main pole 410. For instance, as shown in FIG. 4B, a light source 414 such as a laser illuminates a near field transducer 416 of known type via a waveguide 418.

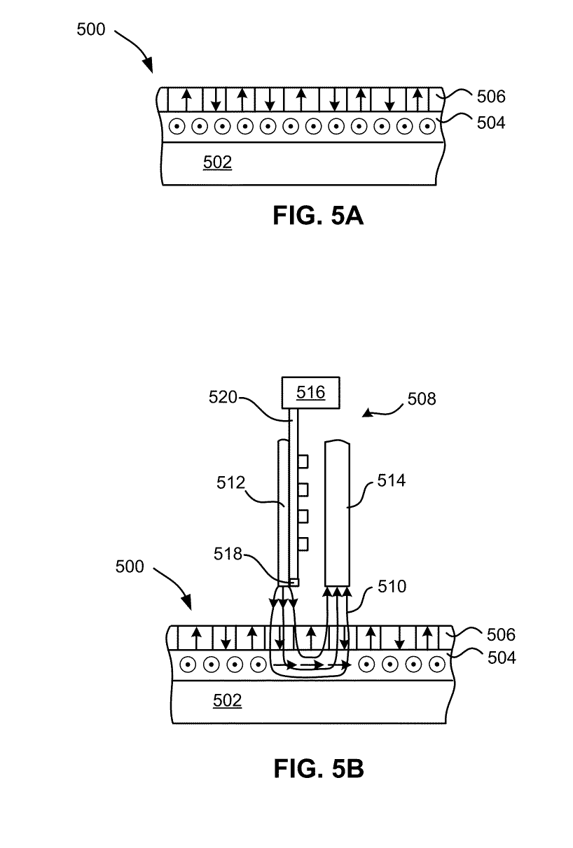

Improvements in longitudinal recording media have been limited due to issues associated with thermal stability and recording field strength. Accordingly, pursuant to the current push to increase the areal recording density of recording media, perpendicular recording media (PMR) has been developed and found to be superior to longitudinal recording media. FIG. 5A provides a schematic diagram of a simplified perpendicular recording medium 500, which may also be used with magnetic disc recording systems, such as that shown in FIG. 1. As shown in FIG. 5A, the perpendicular recording medium 500, which may be a recording disc in various approaches, comprises at least a supporting substrate 502 of a suitable non-magnetic material (e.g., glass, aluminum, etc.), and a soft underlayer 504 of a material having a high magnetic permeability positioned above the substrate 502. The perpendicular recording medium 500 also includes a magnetic recording layer 506 positioned above the soft underlayer 504, where the magnetic recording layer 506 preferably has a high coercivity relative to the soft underlayer 504. There may be one or more additional layers (not shown), such as an “exchange-break” layer or “interlayer”, between the soft underlayer 504 and the magnetic recording layer 506.

The orientation of magnetic impulses in the magnetic recording layer 506 is substantially perpendicular to the surface of the recording layer. The magnetization of the soft underlayer 504 is oriented in (or parallel to) the plane of the soft underlayer 504. As particularly shown in FIG. 5A, the in-plane magnetization of the soft underlayer 504 may be represented by an arrow extending into the paper.

FIG. 5B illustrates the operative relationship between a perpendicular head 508 and the perpendicular recording medium 500 of in FIG. 5A. As shown in FIG. 5B, the magnetic flux 510, which extends between the main pole 512 and return pole 514 of the perpendicular head 508, loops into and out of the magnetic recording layer 506 and soft underlayer 504. The soft underlayer 504 helps focus the magnetic flux 510 from the perpendicular head 508 into the magnetic recording layer 506 in a direction generally perpendicular to the surface of the perpendicular magnetic medium 500. Accordingly, the intense magnetic field generated between the perpendicular head 508 and the soft underlayer 504, enables information to be recorded in the magnetic recording layer 506. The magnetic flux is further channeled by the soft underlayer 504 back to the return pole 514 of the head 508.

As noted above, the magnetization of the soft underlayer 504 is oriented in (parallel to) the plane of the soft underlayer 504, and may represented by an arrow extending into the paper. However, as shown in FIG. 5B, this in plane magnetization of the soft underlayer 504 may rotate in regions that are exposed to the magnetic flux 510.

It should be again noted that in various approaches, the perpendicular head 508 may be configured for heat assisted magnetic recording (HAMR). Accordingly, for HAMR operation, the perpendicular head 508 may include a heating mechanism of any known type to heat, and thus lower the effective coercivity of, a localized region on the magnetic media surface in the vicinity of the main pole 518. For instance, as shown in FIG. 5B, a light source 516 such as a laser illuminates a near field transducer 518 of known type via a waveguide 520.

Except as otherwise described herein with reference to the various inventive embodiments, the various components of the structures of FIGS. 1-5B, and of other embodiments disclosed herein, may be of conventional materials and design, and fabricated using conventional techniques, as would be understood by one skilled in the art upon reading the present disclosure.

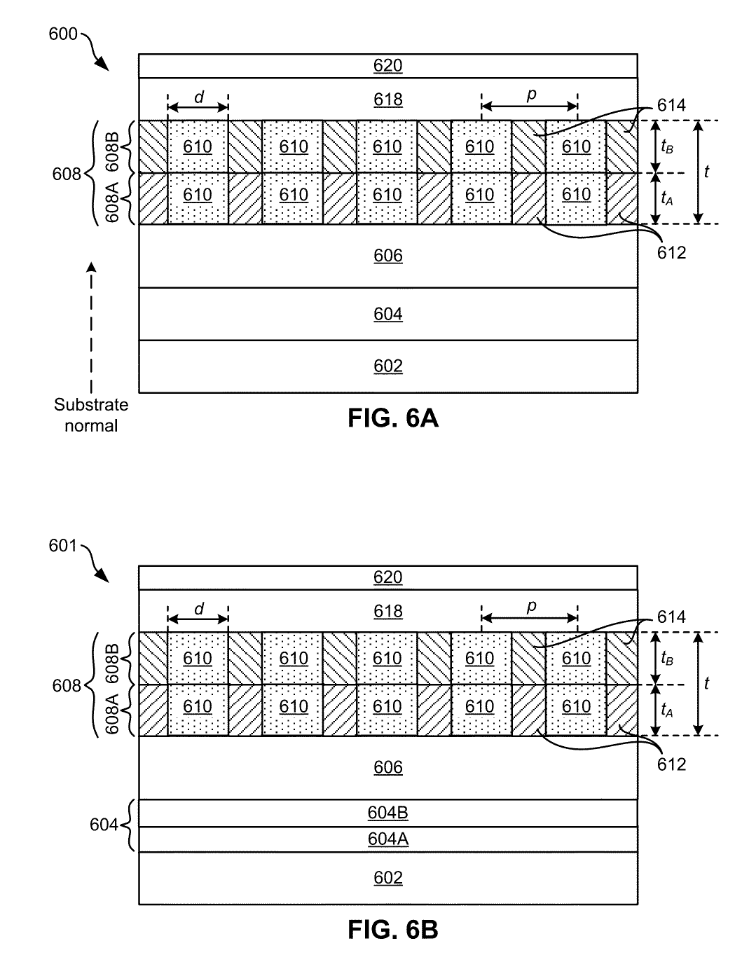

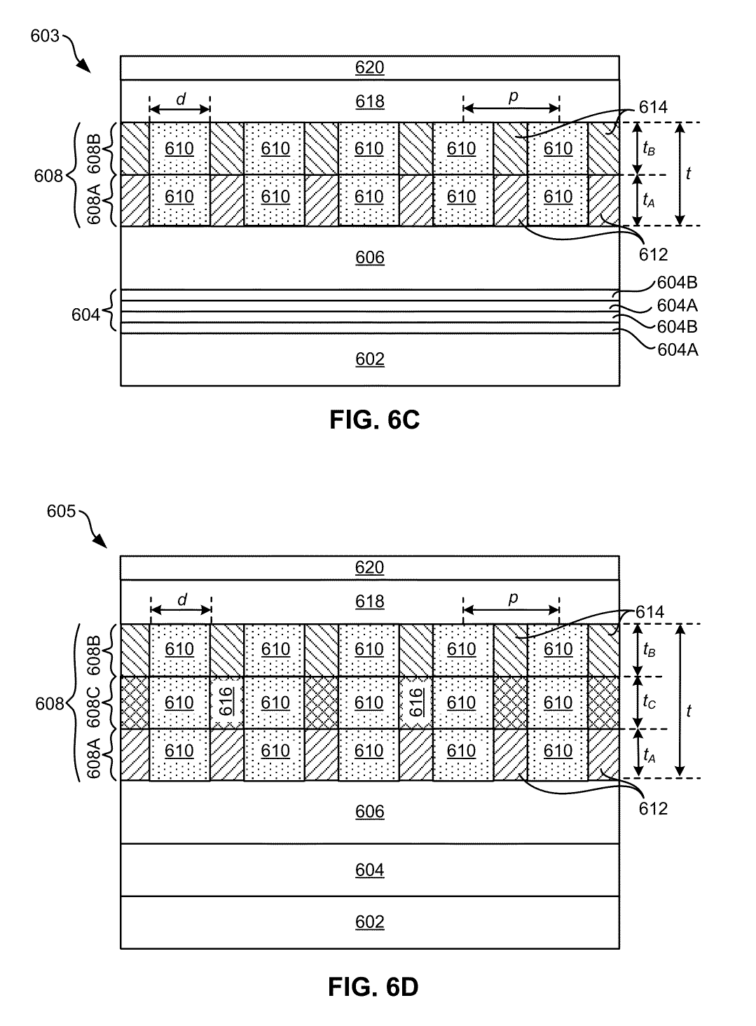

Referring now to FIGS. 6A-6D, portions of magnetic recording media 600, 601, 603, 605 are shown according to various exemplary embodiments. As an option, the magnetic recording media 600, 601, 603, 605 may be implemented in conjunction with features from any other embodiment listed herein, such as those described with reference to the other FIGS. Of course, the magnetic recording media 600, 601, 603, 605, and others presented herein may be used in various applications and/or in permutations which may or may not be specifically described in the illustrative embodiments listed herein. For instance, the magnetic recording media 600, 601, 603, 605 may include more or less layers than those shown in FIGS. 6A-6D, in various approaches. It should be further noted that equivalent layers in the magnetic recording media 600, 601, 603, 605 are designated by identical reference numerals. Finally, the magnetic media 600, 601, 603, 605 and others presented herein may be used in any desired environment.

As shown in the embodiment depicted in FIG. 6A, the magnetic recording medium 600 includes a substrate layer 602 comprising a material of high rigidity, such as tempered glass, crystalline glass, Al, Al₂O₃, MgO, Si, thermal oxidized Si, or other suitable substrate material as would be understood by one having skill in the art upon reading the present disclosure. In preferred approaches, the substrate layer 602 includes a material that allows media deposition at elevated temperatures, e.g., on the order of 600-800° C.

As also shown in FIG. 6A, the magnetic recording medium 600 includes a buffer layer structure 604 positioned above the substrate 602. In some approaches, the buffer layer structure 604 may include at least one buffer layer having an amorphous structure. In particular approaches, this amorphous buffer layer may include a Ni-based alloy that comprises one or more additional alloying elements selected from a group consisting of: Nb, Ta, and Zr. In approaches where the amorphous layer includes a NiNb, NiTa, NiNbTa and/or NiNbTraZr alloy, the Nb content may be in a range between about 20 at % to about 70 at %, and the Ta content may be in a range between about 30 at % and 60 at %.

In other approaches, the buffer layer structure 604 may include at least one buffer layer configured to function as a heat sink layer, i.e., configured to conduct or direct heat away from the magnetic recording layer structure 608 during a write operation. In various approaches, this heat sink layer buffer may include a material having a high thermal conductivity (e.g., greater than 30 W/m-K, preferably greater than 100 W/m-K), which may be particularly useful for HAMR. In preferred approaches, this heat sink buffer layer may preferably have a higher thermal conductivity than the underlayer 606. In further approaches, the heat sink buffer layer may have a body centered cubic (bcc) structure and a crystallographic orientation that is substantially aligned with the crystallographic orientation of the underlayer 606. In such approaches, the crystallographic orientations of both the heat sink buffer layer and the underlayer 606 may be aligned substantially along the substrate normal (i.e., an axis perpendicular the upper surface of the substrate, as indicated by dotted arrow in FIG. 6A). In various approaches, this heat sink buffer layer may be a plasmonic layer. Suitable materials for the heat sink buffer layer may include, but are not limited to, Cr, Mo, Al, Au, Cu, Ag, Ru and alloys thereof.

In yet more approaches, the buffer layer structure 604 may include at least one amorphous buffer layer and at least one heat sink buffer layer. FIG. 6B illustrates one embodiment where the buffer layer structure 604 includes an amorphous buffer layer 604A and heat sink buffer layer 604B positioned thereabove. It is important to note that the relative positions of the amorphous and heat sink buffer layers 604A, 604B are not limited to the configuration shown in FIG. 6B. For example, in some approaches, the heat sink buffer layer 604B may be positioned below the amorphous buffer layer 604A such that the amorphous buffer layer 604A is positioned between the heat sink buffer layer 604B and the underlayer 606.

In additional approaches, the buffer layer structure 604 may include a plurality of buffer layers, where at least one, some, the majority, or all of said buffer layers are amorphous. In alternative approaches, the buffer layer structure 604 may include a plurality of buffer layers, where at least one, some, the majority, or all of said buffer layers are heat sink layers. FIG. 6C illustrates one embodiment where the buffer layer structure 604 includes alternating amorphous buffer layers 604A and heat sink buffer layers 604B. In one approach, each of these alternating amorphous buffer layers 604A may include a Ni-based alloy which may be the same (e.g., have the same alloying elements) or different (i.e., have different alloying elements) from one another. Similarly, each of the alternating heat sink buffer layers 604B may include a crystalline material that is the same or different from one another. Preferably, the crystalline material included in each of the alternating heat sink buffer layers 604B may have a bcc structure and a crystallographic orientation that is substantially aligned with the crystallographic orientation of the underlayer 606.

Referring again to the magnetic recording medium 600 shown in FIG. 6A, the underlayer 606 is positioned above the buffer structure 604. The underlayer 606, which may also be referred herein as an orientation controlling or texture defining layer, may be configured to control the crystal orientation and the grain separation in the magnetic recording layer structure 608. For instance, the underlayer 606 may be configured to control the crystal orientation of a L1₀ type FePt ordered alloy present within the magnetic recording structure 608, where said alloy preferably has its [001] axis (the easy axis of magnetization) oriented perpendicular to the upper surface of the magnetic recording layer.

In some approaches, the underlayer 606 may include MgO. In approaches where the underlayer 606 includes MgO, the Mg content may be in range between about 40 at % to about 55 at %, and the O content may be in a range between about 40 at % to about 55 at %. Comparable orientation controlling characteristics may be obtained in approaches where impurities are present in an MgO underlayer, provided the impurities are present in an amount of 10 at % or less.

In other approaches, the orientation controlling intermediate underlayer 606 may include one or more cubic crystal compounds including but not limited to SrTiO₃, indium tin oxide (ITO), MnO, TiN, RuAl, etc., and/or alloys thereof. In more approaches, the orientation controlling intermediate layer 606 may include one or more body-centered cubic structure metals including but not limited to Cr, Mo, W, etc., and/or alloys thereof. In yet more approaches, the orientation controlling intermediate layer 606 may include one or more face-centered cubic structure metals including but not limited to Pt, Pd, Ni, Au, Ag, Cu, etc., and/or alloys thereof. In further approaches, these materials suitable for use in the orientation controlling intermediate layer 606 may be combined in plurality to form a laminated-type orientation controlling intermediate layer 606.

While not shown in FIG. 6, the magnetic recording medium 600 may include an optional soft magnetic underlayer configured to promote data recording in the magnetic recording layer structure 608. In some approaches, this optional soft magnetic underlayer may be positioned between the substrate 602 and the underlayer 606. In particular approaches, the optional soft magnetic underlayer may be positioned above or below the buffer layer stack 604. This optional soft magnetic underlayer may include a material having a high magnetic permeability. Suitable materials for the soft magnetic underlayer may include, but are not limited to, Fe, FeNi, FeCo, a Fe-based alloy, a FeNi-based alloy, a FeCo-based alloy, Co-based ferromagnetic alloys, and combinations thereof. In some approaches, this soft magnetic underlayer may include a single layer structure or a multilayer structure. For instance, one example of a multilayer soft magnetic underlayer structure may include a coupling layer (e.g., including Ru) sandwiched between one or more soft magnetic underlayers, where the coupling layer is configured to induce an anti-ferromagnetic coupling between one or more soft magnetic underlayers.

With continued reference to FIG. 6A, the magnetic recording medium 600 includes a magnetic recording layer structure 608 positioned above the underlayer 606. As shown in FIG. 6A, the magnetic recording layer structure 608 comprises a first magnetic recording layer 608A and a second magnetic recording layer 608B positioned thereabove. The first and second magnetic recording layers 608A, 608B each include a plurality of magnetic grains 610. These magnetic grains 610 are preferably characterized by a desirable columnar shape and extend through each of the magnetic recording layers 608A, 608B of the magnetic recording layer structure 608

In preferred approaches, the magnetic grains 610 in each of the first and second magnetic recording layers 608A, 608B may include a L1₀ type FePt ordered alloy. In more approaches, the magnetic grains 610 in each of the first and second magnetic recording layers 608A, 608B may include a L1₀ type FePtX ordered alloy, where X may include one or more of: Ag, Cu, Au, Ni, Mn, etc. In yet more approaches, the one or more additional materials in the L1₀ type FePtX ordered alloy of the first recording layer 608A may be the same or different from the one or more additional materials in the L1₀ type FePtX ordered alloy of the second magnetic recording layer 608B.

As also shown in FIG. 6A, the magnetic grains 610 in the first and second magnetic recording layers 608A, 608B are separated by a segregant, which contributes to the desired columnar shape of the magnetic grains. In particular, the first magnetic recording layer 608A has a first segregant 612 positioned between the magnetic grains thereof. In preferred approaches, the first segregant 612 includes boron nitride (BN). In some approaches, the BN content in the first segregant may be in a range between about 30 to about 100 vol %.

As additionally shown in FIG. 6A, the second magnetic recording layer 608B has a second segregant 614 positioned between the magnetic grains thereof. In preferred approaches, the second segregant 614 includes one or more oxides. Suitable oxides may include, but are not limited to, SiO₂, TiO₂, Cr₂O₃, Ta₂O₅, B₂O₃, MgO and Al₂O₃. In some approaches, the oxide content in the second segregant may be in range between about 30 to about 100 vol %.

In approaches where the magnetic grains 610 of the first and second magnetic recording layers 608A, 608B include at least a L1₀ type FePt ordered alloy, the first segregant 612 and/or the second segregant 614 may include one or more materials having a thermal conductivity that is lower than the thermal conductivity of FePt. In some approaches, an amount (in vol %) of the second segregant 614 in the second magnetic recording layer 608B is greater than an amount (in vol %) of the first segregant 612 in the first magnetic recording layer 608A.

In further approaches, the total thickness, t, of the magnetic recording layer structure 608 may be in a range between about 4 to about 20 nm, but could be higher or lower depending on the desired embodiment. In preferred approaches, the total thickness, t, of the magnetic recording layer structure 608 may be in a range between about 8 to about 15 nm. In additional approaches, the thickness, t_{A}, of the first magnetic recording layer 608A may be about 20% to about 80% of the total thickness, t, of the magnetic recording layer structure 608.

As shown in FIG. 6A, an average center-to-center spacing or pitch, p, of the magnetic grains 610 in the first and second magnetic recording layers 608A, 608B may be in a range between about 2 nm to about 11 nm. Furthermore, an average diameter, d, of the magnetic grains 610 may preferably be in a range between about 2 nm to about 10 nm, but could be higher or lower depending on the desired embodiment. In more approaches, the magnetic grains 610 may have an average aspect ratio (i.e., total thickness t to diameter d) of about 1.2, but could be higher or lower depending again on the desired embodiment.

Although not shown in FIG. 6A, the magnetic recording layer structure 608 may include additional magnetic recording layers, e.g., a third magnetic layer (e.g., see 608C of FIG. 6D), a fourth magnetic layer, a fifth magnetic layer, etc. Each of these additional magnetic recording layers, if present, may also include a plurality of magnetic grains 610 separated by a segregant material 616, where the magnetic grains 610 and the segregant material 616 may include any of the suitable materials, compositions and/or structures disclosed herein. However, in approaches where the magnetic recording layer structure 608 includes a plurality of granular magnetic recording layers, the innermost granular magnetic recording layer (i.e., the granular magnetic recording layer positioned closest to the substrate, see layer 608A in FIG. 6D) may include a BN segregant material, wherein the outermost granular magnetic recording layer (i.e. the granular magnetic recording layer positioned farthest to the substrate and closest to the upper surface of the magnetic medium, see layer 608B in FIG. 6D) may include a segregant material having one or more oxides.

Regardless of how many magnetic recording layers are included in the magnetic recording layer structure 608, preferably all of the magnetic recording layers may have a similar magnetic grain pitch, p. The magnetic grain pitch may be due to the conformal growth on the lowermost magnetic layer that is transferred to the magnetic layers formed there above.

Moreover, the first and second magnetic recording layers 608A, 608B may be formed via a sputtering process. According to one particular approach, the magnetic grain material(s) and one or more segregant component(s) of the first magnetic recording material 608A may be sputtered from the same target; however, in another approach, the magnetic grain material(s) and/or segregant component(s) of the first magnetic recording material 608A may be sputtered from their respective targets. Likewise, the magnetic grain material(s) and one or more segregant component(s) of the second magnetic recording material 608B may be sputtered from the same target in one approach or be sputtered from their respective targets in another approach.

In preferred approaches, the magnetic grain and segregant materials of the first magnetic recording layer 608A are deposited onto the magnetic recording medium 600 at the same time. In similar preferred approaches, the magnetic grain and segregant materials of the second magnetic recording layer 608B are deposited onto the magnetic recording medium 600 at the same time. Additionally, said deposition preferably occurs in a heated environment, e.g., from about 400° C. to about 800° C., in approaches where the first and/or second magnetic recording layers 608A, 608B include a L1₀ type FePt ordered alloy. The FePt-segregant systems in the first and/or second magnetic recording layers 608A, 608B self-assemble to form isolated magnetic grains surrounded by segregant material located along the grain boundaries, as magnetic and segregant materials do not form a solid solution even at high temperature. Thus, the first and/or second magnetic recording layers 608A, 608B have an alternating FePt/segregant/FePt/segregant, etc., configuration in the in-plane direction (i.e., the lateral direction), and an uninterrupted FePt magnetic grain configuration extending in the vertical direction of the magnetic recording structure 608 (i.e., extending throughout the total thickness of the magnetic recording structure 608). As a result, the thermal conductivity of the first and/or second magnetic recording layers 608A, 608B in the lateral direction may be reduced due to the presence of multiple FePt/segregant interfaces, and is typically about 5-20 times smaller than in the thermal conductivity associated with the vertical direction.

In yet further approaches, the first and second magnetic recording layers 608A, 608B may be patterned magnetic recording layers. In patterned recording media, the ensemble of ferromagnetic grains that form a bit are replaced with a single isolated magnetic region, or island, that may be purposefully placed in a location where the write transducer expects to find the bit in order to write information and where the readback transducer expects to detect the information stored thereto. To reduce the magnetic moment between the isolated magnetic regions or islands in order to form the pattern, magnetic material is destroyed, removed or its magnetic moment substantially reduced or eliminated, leaving nonmagnetic regions therebetween. There are two types of patterned magnetic recording media: discrete track media (DTM) and bit patterned media (BPM). For DTM, the isolated magnetic regions form concentric data tracks of magnetic material, where the data tracks are radially separated from one another by concentric grooves of nonmagnetic material. In BPM, the isolated magnetic regions form individual bits or data islands which are isolated from one another by non-magnetic material/crystal grain boundaries (e.g. a segregant). Each bit or data island in BPM includes a single magnetic domain, which may be comprised of a single magnetic grain or a few strongly coupled grains that switch magnetic states in concert as a single magnetic volume.

While not shown in FIG. 6A, the magnetic recording medium 600 may include one or more optional capping layers above the magnetic recording layer structure 608. The one or more capping layers may be configured to mediate the intergranular coupling of the magnetic grains present in the first and second magnetic recording layers 608A, 608B. The optional one or more capping layers may include, for example, a Co-, CoCr-, CoPtCr-, and/or CoPtCrB-based alloy, or other material suitable for use in a capping layer as would be recognized by one having skill in the art upon reading the present disclosure.

Again with reference to FIG. 6A, a protective overcoat layer 618 may be positioned above the magnetic recording layer structure 608 and/or the one or more capping layers if present. The protective overcoat layer 618 may be configured to protect the underlying layers from wear, corrosion, etc. This protective overcoat layer 618 may be made of, for example, diamond-like carbon, carbon nitride, Si-nitride, BN or B4C, etc. or other such materials suitable for a protective overcoat as would be understood by one having skill in the art upon reading the present disclosure.

A lubricant layer 620 may also be positioned above the protective overcoat layer 618, as shown in FIG. 6A. The material of the lubricant layer 620 may include, but is not limited to perfluoropolyether, fluorinated alcohol, fluorinated carboxylic acids, etc., or other suitable lubricant material as known in the art.

The formation of the magnetic recording media 600, 601, 603, 605 shown in FIGS. 6A-6D, respectively, may be achieved via known deposition and processing techniques. For instance, deposition of each of the layers present in the magnetic recording media 600, 601, 603, 605 may be achieved via DC magnetron sputtering, RF magnetron sputtering, molecular beam epitaxy, etc., or other such techniques as would be understood by one having skill in the art upon reading the present disclosure. Among these techniques, sputtering deposition techniques have been used for mass production purposes due to its relatively high film formation speed and capacity to control the fine structure and the distribution of film thickness of a thin film.

Illustrative Embodiments and Comparative Examples

The following illustrative embodiments describe the novel magnetic media disclosed herein, particularly those including a first granular magnetic recording layer with grain boundary material comprising primarily BN and a second granular magnetic recording layer with a grain boundary material comprising primarily an oxide. Comparative examples are also provided to illustrate the differences between conventional magnetic media and the illustrative embodiments of the novel magnetic media disclosed herein. It is important to note that the following illustrative embodiments do not limit the invention in anyway. It should also be understood that variations and modifications of these illustrative embodiments may be made by those skilled in the art without departing from the spirit and scope of the invention.

The perpendicular magnetic recording media described in the following illustrative embodiments and comparative examples were fabricated using an in-line high-speed sputtering apparatus. This apparatus included a plurality of process chambers for film formation, a dedicated chamber for heating, and a chamber for introducing and ejecting a substrate. Each of these process chambers was evacuated independently to a pressure of 1×10⁻⁴ Pa or lower, after which a carrier with a substrate mounted thereon was moved to each chamber in order to carry out successive processes. The substrate was heated in the dedicated heating chamber, where the temperature during heating was controlled by monitoring the time in which power to the heater was turned on. A thermocouple was used to measure the temperature for a proportional-integral-derivative (PID) temperature controller.

An atomic force microscope (AFM) was used to assess surface roughness of the perpendicular magnetic recording media described below. The mean squared value (Rq) of surface roughness was used as an indicator for assessing roughness.

### Illustrative Embodiment 1 vs. Comparative Examples 1-3

Illustrative Embodiment 1 corresponds to a perpendicular magnetic recording medium having the basic structure of the medium 600 shown in FIG. 6A. Specially, the perpendicular magnetic recording medium of Illustrative Embodiment 1 includes the following layers deposited on the substrate in the following order: a Ni₆₂Ta₃₈ buffer layer having a thickness of about 100 nm; a MgO underlayer having a thickness of about 6 nm; a first magnetic recording layer having a thickness of about 5 nm and an average composition of (Fe₃₉Pt₄₉Ag₁₂)₇₀(BN)₁₈(C)₁₂ by volume ratio ((Fe₄₅Pt₄₅Ag₁₀)₆₈(BN)_{13.5}(C)_{18.5} by molar ratio); a second magnetic recording layer having a thickness of about 7 nm and an average composition of (Fe₃₉Pt₄₉Ag₁₂)₇₀(BN)₁₈(SiO₂)₁₂ by volume ratio ((Fe₄₅Pt₄₅Ag₁₀)_{79.5}(BN)_{15.5}(SiO₂)₅ by molar ratio); and a C protective overcoat layer having a thickness of about 3 nm. Following this film formation, a lubricant layer having a thickness of about 1 nm was coated on the C protective overcoat layer.

Unless otherwise specified, the composition of the magnetic recording layer(s) is indicated by volume ratio and molar ratio, whereas the composition of the other layers are indicated by molar ratio (atomic ratio).

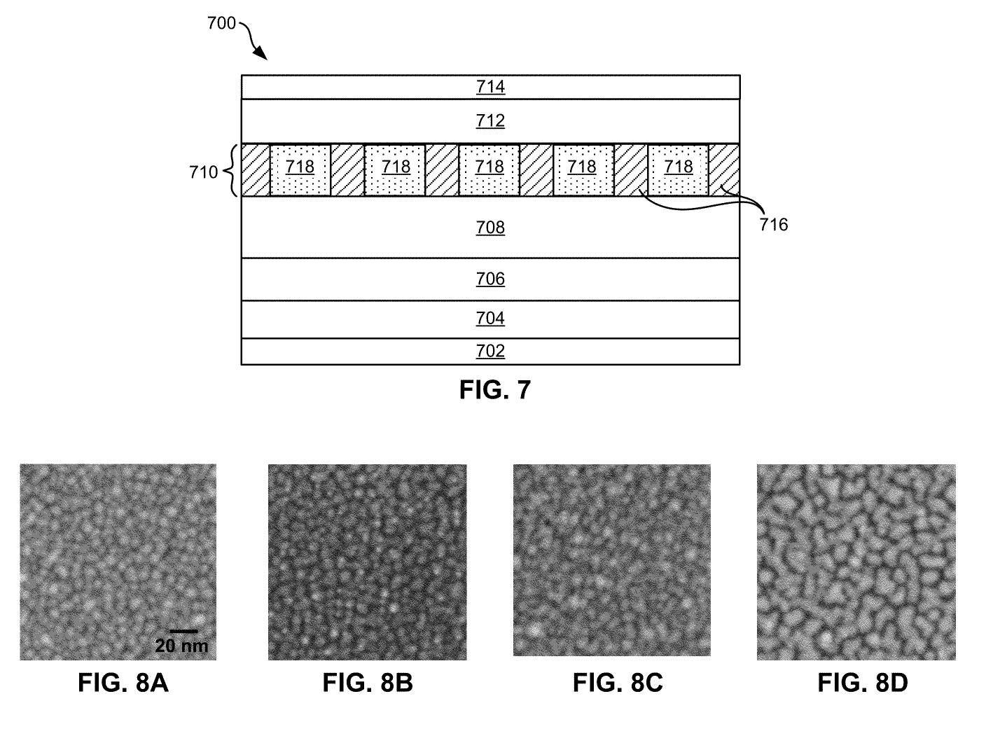

Comparative Examples 1-3 correspond to three different perpendicular magnetic recording media, each of which have the basic structure of the medium 700 shown in FIG. 7. As shown in FIG. 7, the following layers are deposited on the substrate 702 in the following order: an Ni₆₂Ta₃₈ layer buffer layer 704 having a thickness of about 100 nm; an Ni₈₆Cr₆W₈ barrier layer 706 having a thickness of about 1 nm; an MgO underlayer 708 having a thickness of about 6 nm; a magnetic recording layer 710 having a thickness of about 12 nm; and a C protective overcoat layer 712 having a thickness of about 3 nm. Following this film formation, a lubricant layer 714 having a thickness of about 1 nm was coated on the C protective overcoat layer 712.

The perpendicular magnetic recording media corresponding to Comparative Examples 1-3 differ from one another only with respect to the segregant material 716 that surrounds the magnetic grains 718 in their respective magnetic recording layer 710. For instance, Comparative Example 1 has a magnetic recording layer with an average composition of (Fe₃₉Pt₄₉Ag₁₂)₇₀(C)₃₀ by volume ratio ((Fe₄₅Pt₄₅Ag₁₀)₆₀(C)₄₀ by molar ratio). Comparative Example 2 has a magnetic recording layer with an average composition of (Fe₃₉Pt₄₉Ag₁₂)₇₀(BN)₃₀ by volume ratio. Comparative Example 3 has a magnetic recording layer with an average composition of (Fe₃₉Pt₄₉Ag₁₂)₇₀(SiO₂)₃₀ by volume ratio.

Moreover, it is important to note that the perpendicular magnetic recording media corresponding to Comparative Examples 1-3 only include a single magnetic recording layer 710, whereas the perpendicular recording medium of Illustrative Embodiment 1 includes first and second magnetic recording layers.

FIGS. 8A-D show scanning electron microscope (SEM) images of the grain size for the perpendicular magnetic recording media of Illustrative Embodiment 1, Comparative Example 1, Comparative Example 2, and Comparative Example 3, respectively. Grain size was observed in the SEM images because the secondary electron intensity differed due to irregularities and differences in the grain and grain boundary materials. Accordingly, the number of grains per unit surface area was investigated for each of these perpendicular magnetic recording media, and the grain pitch was calculated based on the assumption that the grains have a round shape as viewed from above.

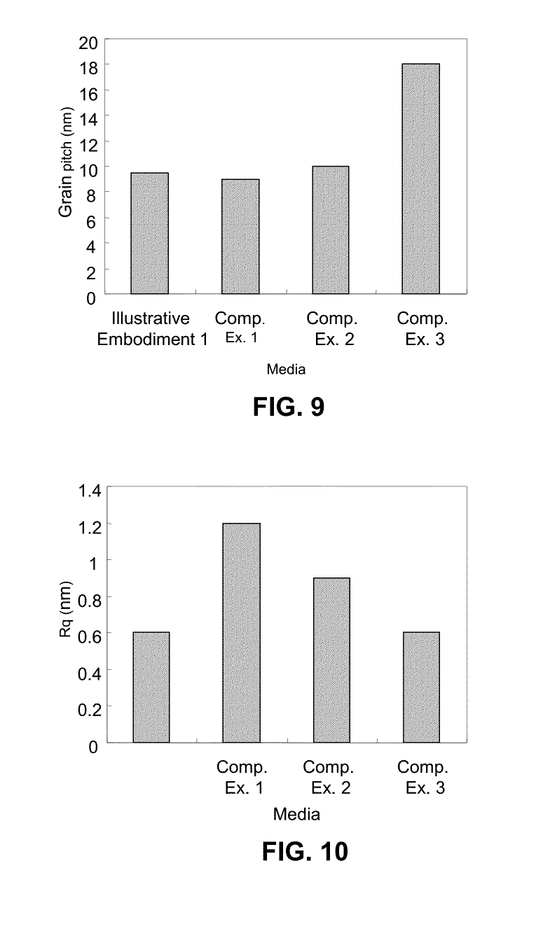

FIG. 9 shows the average grain pitch for the perpendicular magnetic recording media of Illustrative Embodiment 1, and Comparative Examples 1-3. Magnetic grains that are well separated have a narrow grain pitch, whereas grains that are not sufficiently separated have a wide grain pitch. FIGS. 8A-D and 9 indicate that the grains in the perpendicular magnetic recording media of Example 1 and Comparative Examples 1 and 2 were well separated.

FIG. 10 shows the surface roughness (Rq) for the perpendicular magnetic recording media of Illustrative Embodiment 1, and Comparative Examples 1-3. The surface roughness was analyzed using an atomic force microscope (AFM). As shown in FIG. 10, the media of Illustrative Embodiment 1 and Comparative Example 3 had smooth surfaces with an Rq value of 0.7 or less. Conversely, the media of Comparative Examples 2 and 3 had a large Rq value of about 0.9 or more. Perpendicular magnetic recording media with such poor surface roughness (e.g., a Rq value of about 0.9 or more) typically have poor floating characteristics.

Based on FIGS. 8A-10, several conclusions may be drawn. For instance, perpendicular magnetic recording medium with a magnetic recording layer having a C grain boundary material (as in Comparative Example 1) or a BN grain boundary material (as in Comparative Example 2) exhibit good grain separation but a high surface roughness and thus poor floating characteristics. Moreover, a perpendicular magnetic recording medium with a magnetic recording layer having a SiO₂ grain boundary material (as in Comparative Example 2) may exhibit a low surface roughness and thus good floating characteristics, but insufficient grain separation. However, for a perpendicular magnetic recording medium with dual magnetic recording layers having different grain boundary materials (as in Illustrative Embodiment 1), one layer can promote grain separation whereas the second layer can reduce surface roughness, thereby producing a medium that has both good grain separation and a smooth surface. Accordingly, an perpendicular magnetic recording medium with (1) a first magnetic recording layer having a L10 type FePt alloy and a BN segregant material and (2) a second magnetic recording layer having a L10 type FePt alloy and a oxide-based segregant material may exhibit good grain separation, low surface roughness, minimal spread of heat in the in-plane direction during recording, and a narrow recording width. This result indicates that formation of a dual magnetic recording layer structure, where a first magnetic recording layer includes an effective amount of a grain boundary material to promote good grain separation, and where a second magnetic recording layer includes an effective amount of a grain boundary material to promote lower surface roughness, may ultimately achieve a medium having good grain separation and surface roughness.

### Illustrative Embodiment 1 vs. Comparative Example 4

Comparative Example 4 corresponds to a perpendicular magnetic recording medium having the basic structure of medium 600 shown in FIG. 6A. Specially, the perpendicular magnetic recording medium of Comparative Example 4 includes the following layers deposited on the substrate in the following order: a Ni₆₂Ta₃₈ buffer layer having a thickness of about 100 nm; a MgO underlayer having a thickness of about 6 nm; a first magnetic recording layer having a thickness of about 5 nm and an average composition of (Fe₃₉Pt₄₉Ag₁₂)₇₀(C)₃₀ by volume ratio ((Fe₄₅Pt₄₅Ag₁₀)₆₀(C)₄₀ by molar ratio); a second magnetic recording layer having a thickness of about 7 nm and an average composition of (Fe₃₉Pt₄₉Ag₁₂)₇₀(BN)₁₈(C)₁₂ by volume ratio ((Fe₄₅Pt₄₅Ag₁₀)₆₈(BN)_{13.5}(C)_{18.5} by molar ratio); and a C protective overcoat layer having a thickness of about 3 nm. Following this film formation, a lubricant layer having a thickness of about 1 nm was coated on the C protective overcoat layer.

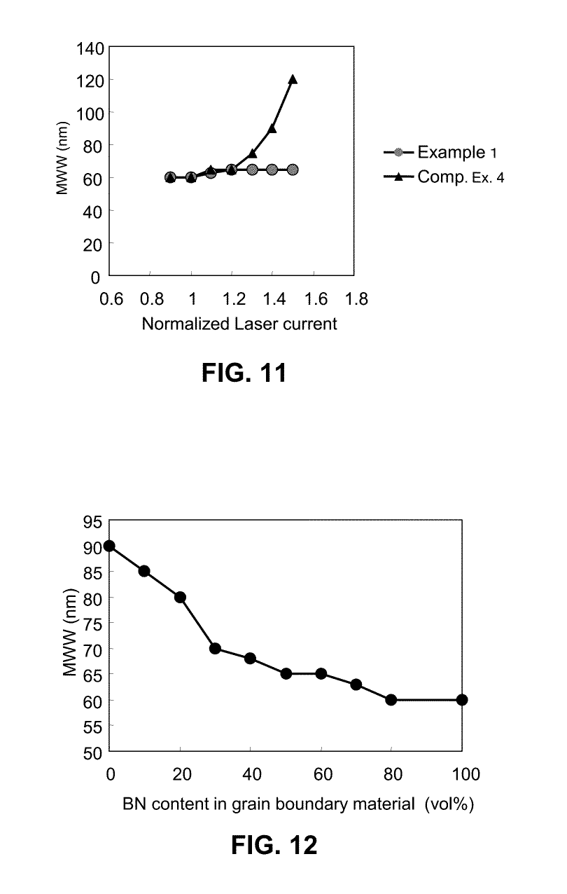

Illustrative Embodiment 1 and Comparative Example 4 were assessed for recording width (RW). FIG. 11 shows a plot of the recording width (magnetic write width MWW) versus the laser current applied during recording for the perpendicular magnetic recording media of Illustrative Embodiment 1 and Comparative Example 4. On the horizontal axis of FIG. 11, the laser current at which the carrier-to-noise ratio (CNR) in each medium is 20 dB is normalized to 1. The vertical axis of FIG. 11 represents the recording width when recording a signal having a frequency of 200 kfci.

As shown in FIG. 11, there was no difference in the MWW at a laser current up to 1.2 for the media of Illustrative Embodiment 1 and Comparative Example 4. However, as also evident in FIG. 11, the MWW of the medium of Comparative Example 4 markedly increased at laser currents greater than 1.2. In contrast, the media of Illustrative Embodiment 1 displayed no sudden increase in the MWW even at laser currents greater than 1.2, and no ill effects were found on adjacent tracks. This difference in the MWW results was due to the grain boundary materials present in the magnetic recording layers. For example, in approaches where the grain boundary material of the entire magnetic recording layer includes primarily C (as in Comparative Example 4), the heat applied during recording tends to spread in the in-plane direction of the layer because the primarily C-based grain boundary material has a comparable or higher thermal conductivity than the FePt magnetic grains. However, in approaches where the grain boundary material of the entire magnetic recording layer includes BN and an oxide (as in Illustrative Embodiment 1), the individual FePt magnetic grains will be surrounded by a grain boundary having lower thermal conductivity than FePt, which has an insulating effect and minimizes the spread of heat in the in-plane direction of the layer during recording.

Accordingly, formation of a dual magnetic recording layer structure, where a first magnetic recording layer includes a grain boundary material with good grain separation, and where a second magnetic recording layer includes a grain boundary material having a thermal conductivity lower than FePt and a reduced surface roughness, may ultimately achieve a medium having good grain separation, low surface roughness and a narrow track width.

FIG. 12 and Table 1 illustrate the relationship between the magnetic write width (MWW) and the BN content in the grain boundary material of the first magnetic layer of the Illustrative Embodiment 1.

TABLE 1

| BN content in | | BN content in |
|---|---|---|
| grain boundary material | Recording | grain boundary material |
| of first magnetic | width | of first magnetic |
| recording layer (vol %) | MWW (nm) | recording layer (mol %) |
| 100 | 60 | 100 |
| 80 | 60 | 65.8 |
| 70 | 63 | 53.3 |
| 60 | 65 | 42.3 |
| 50 | 65 | 32.7 |
| 40 | 68 | 24.4 |
| 30 | 70 | 17.3 |
| 20 | 80 | 10.9 |
| 10 | 85 | 5.1 |
| 0 | 90 | 0 |

With respect to the vertical axis of FIG. 12, the laser current at which the CNR in the medium is 20 dB is normalized to 1, and the condition under which the laser current was 1.4 was compared to the laser current margin. The horizontal axis in FIG. 12 represents the volume percentage of the BN in the grain boundary material based on the total volume of the grain boundary material in the first magnetic recording layer, wherein the total volume of the grain boundary material is set at 100%.

As indicated in both Table 1 and FIG. 12, the MWW was narrow when the BN content in the boundary material was high, wherein the MWW increased when the BN content was low and the C content was high. This result may be due to the fact that heat during recording tended to spread in the in-plane direction depending on the grain boundary material. Accordingly, when the BN content in the grain boundary material is about 30 vol % or greater, the recording width may be restricted to about 70 nm or less, which is preferred. Moreover, when the BN content in the grain boundary material is 50 vol % or greater, the recording width can be further narrowed.

It was further found that a comparable effect (such as that shown in Table 1 and FIG. 12) was obtained by substituting an oxide such as SiO₂, TiO₂, or MgO, or a nitride such as SiNₓ for part of the C or BN.

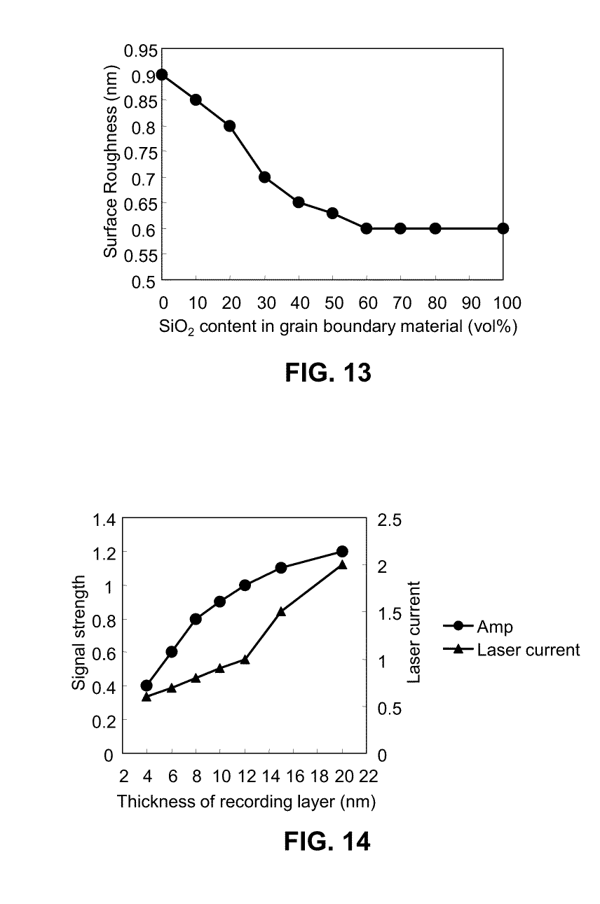

FIG. 13 and Table 2 illustrate the relationship between the surface roughness (Rq) and the oxide (i.e., SiO₂) content in the grain boundary material of the second magnetic layer of the Illustrative Embodiment 1 medium.

TABLE 2

| Oxide content in | | Oxide content in |
|---|---|---|
| grain boundary material | Surface | grain boundary material |
| of second magnetic | roughness | of second magnetic |
| recording layer (vol %) | Rq (nm) | recording layer (mol %) |
| 100 | 0.6 | 100 |
| 80 | 0.6 | 65.8 |
| 70 | 0.6 | 53.8 |
| 60 | 0.6 | 41.8 |
| 50 | 0.63 | 32.5 |
| 40 | 0.65 | 24.4 |
| 30 | 0.7 | 17.1 |
| 20 | 0.8 | 10.7 |
| 10 | 0.85 | 5.1 |
| 0 | 0.9 | 0 |

With respect to FIG. 13, the vertical axis represents Rq (nm), and the horizontal axis represents the volume percentage of the SiO₂ in the grain boundary material based on the total volume of the grain boundary material in the second magnetic recording layer, wherein the total volume of the grain boundary material is set at 100%.

As indicated in both Table 2 and FIG. 13, surface roughness increased when the SiO₂ content in the grain boundary material of the second magnetic recording layer was low; however, increasing the SiO₂ content to 30 vol % or greater may reduce roughness to 0.7 nm or less, which is preferred. Moreover, increasing the SiO₂ content to 50% or greater may further reduce roughness.

FIG. 14 and Table 3 show the relationship between the signal and laser current strengths versus the total thickness of the magnetic recording layer structure (i.e., the total combined thickness of the first and second magnetic recording layers, see e.g., t in FIG. 6A) of the Illustrative Embodiment 1 medium. It is important to note that the film thickness ratio of the first magnetic recording layer to the second magnetic recording layer was kept constant despite varying the total thickness of the magnetic recording layer structure.

TABLE 3

| Total film | | |
|---|---|---|
| thickness of magnetic | Signal strength | Laser current |
| recording layer (nm) | (relative strength) | (relative strength) |
| 4 | 0.4 | 0.6 |
| 6 | 0.6 | 0.7 |
| 8 | 0.8 | 0.8 |
| 10 | 0.9 | 0.9 |
| 12 | 1 | 1 |
| 15 | 1.1 | 1.5 |
| 20 | 1.2 | 2 |

With respect to FIG. 14, the left vertical axis represents the relative signal strength, where the signal strength for a recording layer film thickness of 12 nm is normalized to 1. The right vertical axis represents the laser current at which the recording density per unit surface area reaches a peak value under various conditions, taking the laser current for a recording layer film thickness of 12 nm as 1.

As indicated in both Table 3 and FIG. 14, both the laser current and signal strength were low for a thin (˜2-4 nm) magnetic recording layer structure. In contrast, when the magnetic recording layer structure was thick (˜16-20 nm), the signal and laser current strength were both high, however a high laser current strength increases the load on the recording head. Accordingly, in preferred approaches, the total thickness of the magnetic recording layer structure is in a range between about 8 to 15 nm, or more preferably, in a range between about 10 nm to about 12 nm.

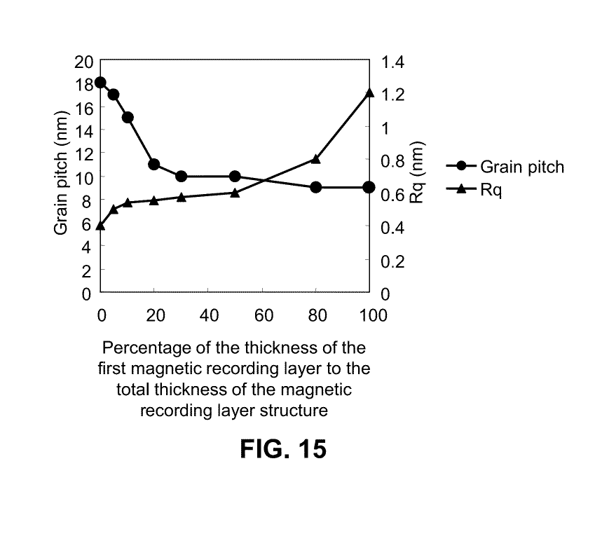

FIG. 15 and Table 4 show the relationship between the percentage thickness of the first magnetic recording layer relative to the total thickness of the magnetic recording layer structure versus the grain pitch and surface roughness of the Illustrative Embodiment 1 medium. It is important to note that the film thickness ratio of the first magnetic recording layer to the second magnetic recording layer was kept constant.

TABLE 4

| Proportion of the thickness | | |
|---|---|---|
| of the first magnetic recording | | Surface |
| layer to the total film thickness | Grain | roughness |
| of the magnetic recording layer (%) | pitch (nm) | Rq (nm) |
| 0 | 18 | 0.4 |
| 5 | 17 | 0.5 |
| 10 | 15 | 0.54 |
| 20 | 11 | 0.55 |
| 30 | 10 | 0.57 |
| 50 | 10 | 0.6 |
| 80 | 9 | 0.8 |
| 100 | 9 | 1.2 |

With respect to FIG. 15, the left vertical axis represents the grain pitch, and the right vertical axis represents the surface roughness (Rq). As indicated in both Table 4 and FIG. 14, decreasing the thickness of the first recording layer reduced the surface roughness, yet undesirably increased the grain pitch. In contrast, increasing the thickness of the first recording layer reduced the grain pitch (and thus improved grain separation), yet increased the surface roughness. Accordingly, to achieve good grain separation (i.e., a low grain pitch) and a low surface roughness, the thickness of the first recording layer is preferably 20% to 80%, and more preferably 30% to 50%, of the total thickness of the magnetic recording layer structure.

### Illustrative Embodiments 2-11

Illustrative Embodiments 2-11 correspond to different perpendicular magnetic recording media, each of which have the basic structure of medium 600 shown in FIG. 6A. Specially, the perpendicular magnetic recording media of Illustrative Embodiments 2-11 include the following layers deposited on the substrate in the following order: a Ni₆₂Ta₃₈ buffer layer having a thickness of about 100 nm; a MgO underlayer having a thickness of about 6 nm; a ˜5 nm thick first magnetic recording layer having a L1₀ type FePt ordered alloy and a segregant (grain boundary) material; a ˜7 nm second magnetic recording layer having a L1₀ type FePt ordered alloy and a segregant (grain boundary) material; and a C protective overcoat layer having a thickness of about 3 nm. Following this film formation, a lubricant layer having a thickness of about 1 nm was coated on the C protective overcoat layer.

As discussed previously with respect to the perpendicular recording medium of Illustrative Embodiment 1, the recording width was narrowed even in approaches where the grain boundary material of the second magnetic recording layer included an oxide other than SiO₂. Consequently, various oxide-based grain boundary materials for use in this second magnetic recording layer were investigated as to crystallinity and corrosion resistance. Each of the media associated with Illustrative Embodiments 1-11 differ only with respect to the grain boundary composition in the second magnetic recording layer.

In order to investigate the crystallinity of the grain boundary material of the second magnetic recording layer, the degree of L1₀ ordering of the FePt magnetic grains therein was investigated. The degree of ordering was assessed by using an X-ray diffractometer to investigate the intensity ratio of the ordering line; specifically, the integrated intensity ratio I₀₀₁/I₀₀₂ of the (001) diffraction peak and the (002) diffraction peak. The greater the intensity ratio, the more advanced the degree of ordering. Moreover, dispersion of the crystal orientation of FePt was also investigated. An X-ray diffractometer was used to investigate crystal orientation by measuring Δθ₅₀ of the (002) diffraction peak. The smaller the angle, the lower the dispersion of orientation.

In order to investigate the corrosion resistance of the grain boundary material of the second magnetic recording layer, an accelerated test was carried out in a constant-temperature tank in which the media of Illustrative Embodiments 1-11 were exposed to three cycles of increasing temperature from room temperature to 70° C. and 90% relative humidity. The media was further held for 100 h at the elevated condition corresponding to 70° C. and 90% relative humidity and subsequently cooled to room temperature after each cycle. The number of defects in the second magnetic recording layer was then investigated at the conclusion of this accelerated test. The number of defects for the medium of Illustrative Embodiment 1 after the accelerated test was taken as the standard. The lower the number of defects, the better the corrosion resistance.

Table 5 summarizes the results for the crystallinity and corrosion resistance associated with the grain boundary materials present in the second magnetic recording layers of the media associated with Illustrative Embodiments 1-11.

TABLE 5

| | Intensity | | No. of defects | Average composition | Average composition |
|---|---|---|---|---|---|
| Illustrative | ratio | Orientation | after accel- | of second magnetic | of second magnetic |
| Embodiments | I₀₀₁/I₀₀₂ | Δθ₅₀ (deg) | erated test | recording layer (vol %) | recording layer (mol %) |
| 1 | 1.7 | 4.5 | 1 | (Fe₃₉Pt₄₉Ag₁₂)₇₀ | (Fe₄₅Pt₄₅Ag₁₀)_{80.6} |
| | | | | (SiO₂)₁₅(BN)₁₅ | (SiO₂)_{6.3}(BN)_{13.1} |
| 2 | 1.6 | 5 | 1 | (Fe₃₉Pt₄₉Ag₁₂)₇₀ | (Fe₄₅Pt₄₅Ag₁₀)82.6 |
| | | | | (SiO₂)20(BN)10 | (SiO₂)8.6(BN)8.8 |
| 3 | 1.6 | 4.5 | 1.3 | (Fe₃₉Pt₄₉Ag₁₂)₇₀ | (Fe₄₅Pt₄₅Ag₁₀)₇₉ |
| | | | | (SiO₂)₁₀(BN)₂₀ | (SiO₂)₄(BN)₁7 |
| 4 | 1.4 | 5.4 | 1.2 | (Fe₃₉Pt₄₉Ag₁₂)₇₀ | (Fe₄₅Pt₄₅Ag₁₀)_{80.9} |
| | | | | (TiO₂)₁₅(BN)₁₅ | (TiO₂)_{10.4}(BN)_{8.8} |
| 5 | 1.4 | 6 | 0.7 | (Fe₃₉Pt₄₉Ag₁₂)₇₀ | (Fe₄₅Pt₄₅Ag₁₀)_{79.5} |
| | | | | (TiO₂)₂₀(BN)₁₀ | (TiO₂)_{7.5}(BN)₁3 |
| 6 | 1.4 | 5.5 | 1 | (Fe₃₉Pt₄₉Ag₁₂)₇₀ | (Fe₄₅Pt₄₅Ag₁₀)_{75.3} |
| | | | | (MgO)₁₅(BN)₁₅ | (MgO)_{12.3}(BN)_{12.4} |
| 7 | 1.5 | 5.7 | 1.1 | (Fe₃₉Pt₄₉Ag₁₂)₇₀ | (Fe₄₅Pt₄₅Ag10)_{75.5} |
| | | | | (MgO)₂₀(BN)₁₀ | (MgO)_{16.3}(BN)_{8.2} |
| 8 | 1.65 | 4.5 | 1 | (Fe₃₉Pt₄₉Ag₁₂)₇₀ | (Fe₄₅Pt₄₅Ag₁₀)_{81.7} |
| | | | | (B₂O₃)₁₅(BN)₁₅ | (B₂O₃)_{5.1}(BN)_{13.2} |
| 9 | 1.67 | 4.4 | 1 | (Fe₃₉Pt₄₉Ag₁₂)₇₀ | (Fe₄₅Pt₄₅Ag₁₀)_{81.6} |
| | | | | (Cr₂O₃)₁₅(BN)₁₅ | (Cr₂O₃)₅(BN)_{13.4} |
| 10 | 1.65 | 4.5 | 1.1 | (Fe₃₉Pt₄₉Ag₁₂)₇₀ | (Fe₄₅Pt₄₅Ag₁₀)_{83.5} |
| | | | | (Ta₂O₅)₁₅(BN)₁₅ | (Ta₂O₅)_{2.9}(BN)_{13.6} |
| 11 | 1.66 | 4.5 | 1.1 | (Fe₃₉Pt₄₉Ag₁₂)₇₀ | (Fe₄₅Pt₄₅Ag₁₀)_{81.2} |
| | | | | (Al₂O₃)₁₅(BN)₁₅ | (Al₂O₃)_{5.6}(BN)_{13.2} |

As indicated in Table 5, approaches where SiO₂ was used for the oxide exhibited good integrated intensity ratios and crystal orientation. In approaches where MgO was used for the oxide, the crystal orientation of the second magnetic recording layer was better as compared to approaches using SiO₂. Further, in approaches where TiO₂ was used, the crystal orientation was better given the improved integrated intensity ratio I₀₀₁/I₀₀₂ as compared to approaches using SiO₂. Finally, in approaches where Cr₂O₃ was used for the oxide, corrosion resistance was better as compared to approaches using SiO₂.

It should also be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A perpendicular magnetic recording medium, comprising:
a substrate;
an underlayer positioned above the substrate; and
a magnetic recording layer structure positioned above the underlayer,
wherein the magnetic recording layer structure comprises at least a first magnetic recording layer and a second magnetic recording layer, the second magnetic layer being positioned above first magnetic recording layer,
wherein the first magnetic recording layer comprises a first segregant material positioned between magnetic grains thereof, the first segregant material being primarily boron nitride (BN),
wherein the second magnetic recording layer comprises a second segregant material positioned between the magnetic grains thereof, the second segregant material being primarily an oxide.

2. The perpendicular magnetic recording medium as recited in claim 1, wherein the oxide is selected from a group consisting of: SiO₂, TiO₂, Cr₂O₃, Ta₂O₅, B₂O₃, MgO, Al₂O₃, and combinations thereof.

3. The perpendicular magnetic recording medium as recited in claim 1, wherein a BN content in the first segregant material is in a range between about 30 to about 100 vol %.

4. The perpendicular magnetic recording medium as recited in claim 1, wherein an oxide content in the second segregant material is in a range between about 30 to about 100 vol %.

5. The perpendicular magnetic recording medium as recited in claim 1, wherein a total thickness of the magnetic recording layer structure is in a range between about 8 to about 15 nm.

6. The perpendicular magnetic recording medium as recited in claim 5, wherein a thickness of the first magnetic recording layer is in a range between about 20% to about 80% of the total thickness of the magnetic recording layer structure.

7. The perpendicular magnetic recording medium as recited in claim 1, wherein the magnetic grains of the first and second magnetic recording layers comprise a L1₀ type FePt ordered alloy.

8. The perpendicular recording medium as recited in claim 7, wherein the magnetic grains of the first and second magnetic recording layers further comprise an additional material selected from the group consisting of: Au, Ag, Cu, Ni, Mn, and combinations thereof.

9. The perpendicular magnetic recording medium as recited in claim 1, wherein the magnetic grains in the first and second magnetic recording layers have an average pitch that is greater than 0 and less than about 10 nm.

10. The perpendicular magnetic recording medium as recited in claim 1, wherein the underlayer includes MgO, wherein the Mg is present in a range between about 40 at % to about 55 at %, wherein the 0 is present in a range between about 40 at % to 55 at %.

11. The perpendicular magnetic recording medium as recited in claim 1, further comprising a buffer layer structure positioned above the substrate and below the underlayer, wherein the buffer layer structure comprises one or more buffer layers.

12. The perpendicular magnetic recording medium as recited in claim 11, wherein at least one of the buffer layers comprises an amorphous Ni-based alloy, the amorphous Ni-based alloy comprising at least one of Nb, Ta and Zr.

13. The perpendicular magnetic recording medium as recited in claim 12, wherein at least one of the buffer layers has a body centered cubic (bcc) structure and a crystallographic orientation that is substantially aligned with a crystallographic orientation of the underlayer.

14. The perpendicular magnetic recording medium as recited in claim 12, wherein at least one of the buffer layers has a higher thermal conductivity than the underlayer.

15. The perpendicular magnetic recording medium as recited in claim 12, wherein the buffer layer structure comprises alternating buffer layers of an amorphous material and crystalline material, the crystalline material having a bcc structure and a crystallographic orientation that is substantially aligned with a crystallographic orientation of the underlayer.

16. A magnetic data storage system, comprising:
at least one magnetic head;
a magnetic medium as recited in claim 1;
a drive mechanism for passing the magnetic medium over the at least one magnetic head; and
a controller electrically coupled to the at least one magnetic head for controlling operation of the at least one magnetic head.

17. A perpendicular magnetic recording medium, comprising:
a substrate; and
a magnetic recording layer structure positioned above the substrate, the magnetic recording layer structure comprising:
a first magnetic recording layer having a first segregant material positioned between magnetic grains thereof; and
a second magnetic recording layer positioned above first magnetic recording layer, the second magnetic recording layer having a second segregant material positioned between the magnetic grains thereof,
wherein the magnetic grains of the first and second magnetic recording layers include a L1₀ type FePt ordered alloy,
wherein at least the second segregant has a thermal conductivity that is less than FePt.

18. The perpendicular magnetic recording medium as recited in claim 17, wherein an amount of the second segregant in the second magnetic recording layer is greater than an amount of the first segregant in the first magnetic recording layer.

19. The perpendicular magnetic recording medium as recited in claim 17, wherein the first segregant is primarily BN, and wherein the second segregant is primarily an oxide selected from a group consisting of: SiO₂, TiO₂, Cr₂O₃, Ta₂O₅, B₂O₃, MgO, Al₂O₃, and combinations thereof.

20. The perpendicular magnetic recording medium as recited in claim 19, wherein a BN content in the first segregant is in a range between about 30 to about 100 vol %, and wherein an oxide content in the second segregant is in a range between about 30 to about 100 vol %.
